(19) United States
(12) Patent Application Publication
(10) Pub. No.: US 2020/0380583 A1
(43) Pub. Date: Dec. 3, 2020

(54) PROMPTLY ADJUST RECOMMENDATIONS TO INCREASE PERFORMANCE IN A WEB SITE

(71) Applicant: Kohl's, Inc., Menomonee Falls, WI (US)

(72) Inventors: Alan Lee, Sunnyvale, CA (US); Ritaja Sur, Sunnyvale, CA (US); Zhiyu Liang, San Jose, CA (US)

(21) Appl. No.: 16/888,505

(22) Filed: May 29, 2020

Related U.S. Application Data
(60) Provisional application No. 62/855,618, filed on May 31, 2019.

(51) Int. Cl. G06Q 30/06; G06Q 30/02; G06F 16/9536

(52) U.S. Cl. CPC G06Q 30/0631; G06F 16/9536; G06Q 30/0243; G06Q 30/0246

(57) ABSTRACT

A recommendation system and method access a recommendation bundle pool including multiple recommendation algorithms, each of which is capable of generating one or more recommendations. A first recommendation bundle comprising two or more recommendation algorithms is selected from the pool. Using the first recommendation bundle, recommendations are generated to provide to visitors to a website. When the recommendation system detects a triggering condition for a scaling cycle, the recommendation system applies a scaling mechanism to increase an exploration of additional recommendation bundles from the recommendation bundle pool. Based on the exploration, the recommendation system selects a second recommendation bundle including algorithms selected from the pool. Recommendations are generated using the second recommendation bundle.

### CROSS-REFERENCE TO RELATED APPLICATION

This application claims the benefit of U.S. Provisional Patent Application No. 62/855,618, filed May 31, 2019, which is incorporated herein by reference in its entirety.

### BACKGROUND

Online retailers provide product recommendations through their web stores or websites to increase sales. These retailers can use any of a variety of existing or customized algorithms to generate these recommendations, both by selecting the products that will be recommended and selecting when or how the recommendations will be presented to website visitors. Once a recommendation has been generated and presented to website visitors, measuring the effectiveness of the recommendation is a time-consuming task that includes capturing constantly changing customer interests and the impact of recommendations on sales, clicks, or other desired metrics. Several existing systems generate recommendations dynamically on a retailer's website using, for example, preconfigured code modules or user click rates. However, the existing systems lack the capability to quickly and in near real-time adapt to the change of customer interests and generate different set of recommendations to suit the current context immediately. Therefore, there exists a need for a recommendation system that will quickly (in near real-time) adapt to the environment to increase the revenue related performance and sales of the retailer's website.

### BRIEF DESCRIPTION OF THE DRAWINGS

FIG. 1 is a block diagram showing some of the components typically incorporated in at least some of the computer systems and other devices on which a recommendation system operates.

FIG. 2 is a system diagram illustrating an example of a computing environment in which a recommendation system operates.

FIG. 3 is a display diagram illustrating components of a recommendation system in accordance with some embodiments.

FIG. 4 illustrates an example webpage of a retailer's website configured in accordance with embodiments of the present technology.

FIG. 5 is a flow diagram illustrating a process performed by a recommendation system to generate recommendations in accordance with embodiments of the present technology.

FIG. 6 is a flow diagram illustrating a process for scaling selection of recommendation bundles in accordance with embodiments of the present technology.

FIGS. 7A-7D illustrate example probability distributions associated with recommendation bundles in accordance with embodiments of the present technology.

### DETAILED DESCRIPTION

A recommendation system and method to promptly adjust to the dynamic changes of user behavior in a retailer's web site, and present recommendations which are more relevant for the current context to drive revenue is disclosed. Implementations of the system can also reduce the website's reaction time to generate new recommendations.

The recommendation system described herein generates recommendations using recommendation bundles, each of which includes multiple recommendation algorithms. In some cases, it can be desirable to generate a specified number of recommendations. For example, a webpage may have slots for a specified number of product recommendations that will be generated dynamically and displayed to a visitor to the webpage. Some recommendation algorithms alone may not generate enough recommendations to fill the specified number of slots. By applying the multiple recommendation algorithms in a bundle, the recommendation system generates a sufficient number of recommendations to fill the specified number of slots.

The recommendation system can select the algorithms to include in a bundle based on measurements of performance of the bundle. Various bundles can be selected and used to generate recommendations that are provided to users, who then have the opportunity to interact with the recommendations (e.g., by clicking on the recommendation to view information about a recommended product). The recommendation system captures metrics indicating whether the recommendations are useful to the customers, such as a click-through rate on displayed recommendations, a frequency at which recommended products are added to an online shopping cart, or a frequency at which recommended items are purchased. One or more recommendation bundles that achieve desired performance metrics can be selected to generate recommendations for future website visitors.

However, the preferences and interests of customers may change after the recommendation system measured a bundle's performance. Customer preferences or interests can change over time for a variety of reasons, whether due to different customers visiting the website, customers having viewed the recommended products already, new products being added to the website, or changing circumstances driving the products customers desire (such as different weather, upcoming holidays, or the passing of holidays). Accordingly, the recommendation system applies a scaling mechanism to respond to dynamic customer interests. When used, for example, to generate product recommendations for a retailer, systems and processes described herein apply scaling mechanisms to critical revenue-related metrics, such as revenue generated per impression, to increase the retailer's revenue.

Although some implementations are described herein with respect to generating recommendations for products sold on a website, the recommendation system can be used to generate recommendations for a variety of other purposes. Some implementations can, for example, be used to generate recommendations in streaming media applications, recommending media content items to users of the applications. Other implementations can be used to generate offers or incentives to send to customers of online stores, physical stores, or service providers to increase revenue of the store or service provider. For example, the recommendation system selects an offer for a percentage off a purchase price (such as 20% off, 30% off, etc.) that will entice customers to make a purchase while still generating net revenue for the retailer.

### System Overview

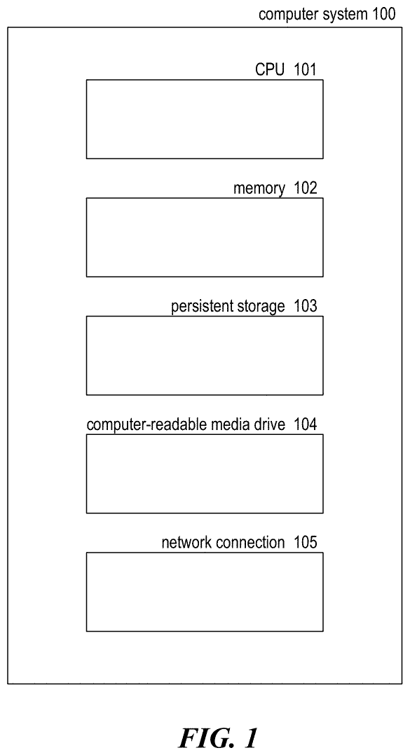

FIG. 1 is a block diagram showing some of the components typically incorporated in at least some of computer systems 100 and other devices on which the recommendation system operates. In various embodiments, these computer systems 100 and other devices can include server computer systems, desktop computer systems, laptop computer systems, netbooks, mobile phones, personal digital assistants, televisions, cameras, automobile computers, electronic media players, etc. In various embodiments, the computer systems and devices include zero or more of each of the following: a central processing unit (“CPU”) 101 for executing computer programs; a computer memory 102 for storing programs and data while they are being used, including the recommendation system and associated data, an operating system including a kernel, and device drivers; a persistent storage device 103, such as a hard drive or flash drive for persistently storing programs and data; a computer-readable media drive 104 that are tangible storage means that do not include a transitory, propagating signal, such as a floppy, CD-ROM, or DVD drive, for reading programs and data stored on a computer-readable medium; and a network connection 105 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. While computer systems configured as described above are typically used to support the operation of the recommendation system, those skilled in the art will appreciate that the recommendation system can be implemented using devices of various types and configurations and having various components.

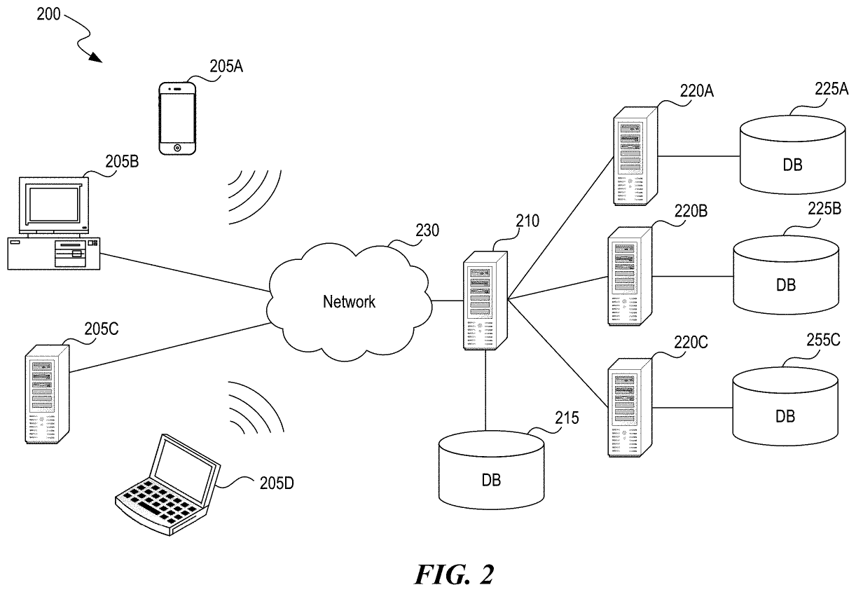

FIG. 2 is a system diagram illustrating an example of a computing environment in which the recommendation system operates in some embodiments. In some implementations, environment 200 includes one or more client computing devices 205A-D, examples of which can include computer system 100 of FIG. 1. Client computing devices 205 operate in a networked environment using logical connections through network 230 to one or more remote computers, such as a server computing device 210.

In some implementations, server 210 is an edge server which receives client requests and coordinates fulfillment of those requests through other servers, such as servers 220A-C. In some implementations, server computing devices 210 and 220 comprise computing systems, such as computer system 100 of FIG. 1. Though each server computing device 210 and 220 is displayed logically as a single server, server computing devices can each be a distributed computing environment encompassing multiple computing devices located at the same or at geographically disparate physical locations. In some implementations, each server 220 corresponds to a group of servers.

Client computing devices 205 and server computing devices 210 and 220 can each act as a server or client to other server/client devices. In some implementations, servers (210, 220A-C) connect to a corresponding database (215, 225A-C). As discussed above, each server 220 can correspond to a group of servers, and each of these servers can share a database or can have its own database. Databases 215 and 225 warehouse (e.g., store) information such as user data (e.g., user identifiers, user profiles, etc.), catalog data, inventory, recommendation bundles, and so on. Though databases 215 and 225 are displayed logically as single units, databases 215 and 225 can each be a distributed computing environment encompassing multiple computing devices, can be located within their corresponding server, or can be located at the same or at geographically disparate physical locations.

Network 230 can be a local area network (LAN) or a wide area network (WAN), but can also be other wired or wireless networks. In some implementations, network 230 is the Internet or some other public or private network. Client computing devices 205 are connected to network 230 through a network interface, such as by wired or wireless communication. While the connections between server 210 and servers 220 are shown as separate connections, these connections can be any kind of local, wide area, wired, or wireless network, including network 230 or a separate public or private network.

Recommendation System

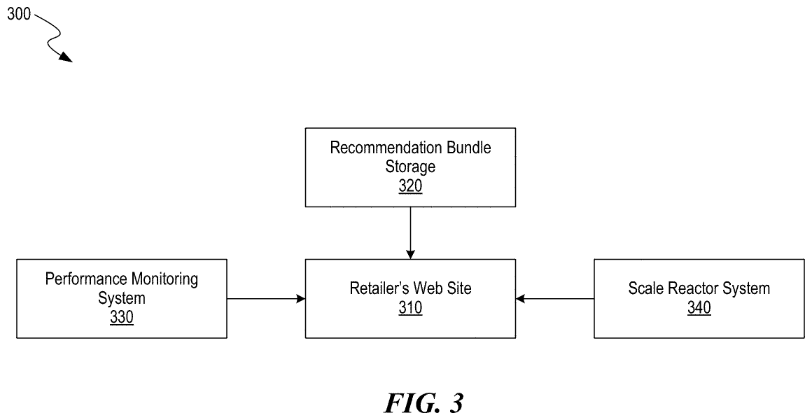

FIG. 3 is a high-level block diagram illustrating a recommendation system 300. As shown in FIG. 3, the recommendation system 300 can include a retailer's website 310, a recommendation bundle storage 320, a performance monitoring system 330, and a scale reactor system 340. Other implementations of the recommendation system 300 can include additional, fewer, or different components, and functionality can be distributed differently between the components. For example, various implementations of the recommendation system 300 can include systems associated with other online or physical entities, instead of or in addition to the retailer's website 310.

The retailer's website 310 is an online store accessible to customers over a network, such as the Internet. The website 310 can include or can be communicatively coupled to a product database that stores information about products available for purchase by visitors to the website. Customers can access the website 310 to view the product information and purchase desired items. The products sold through the website can include, for example, any of a variety of physical goods that are shipped to the purchasing customer, electronic files available for download, or online services that can be accessed upon purchase.

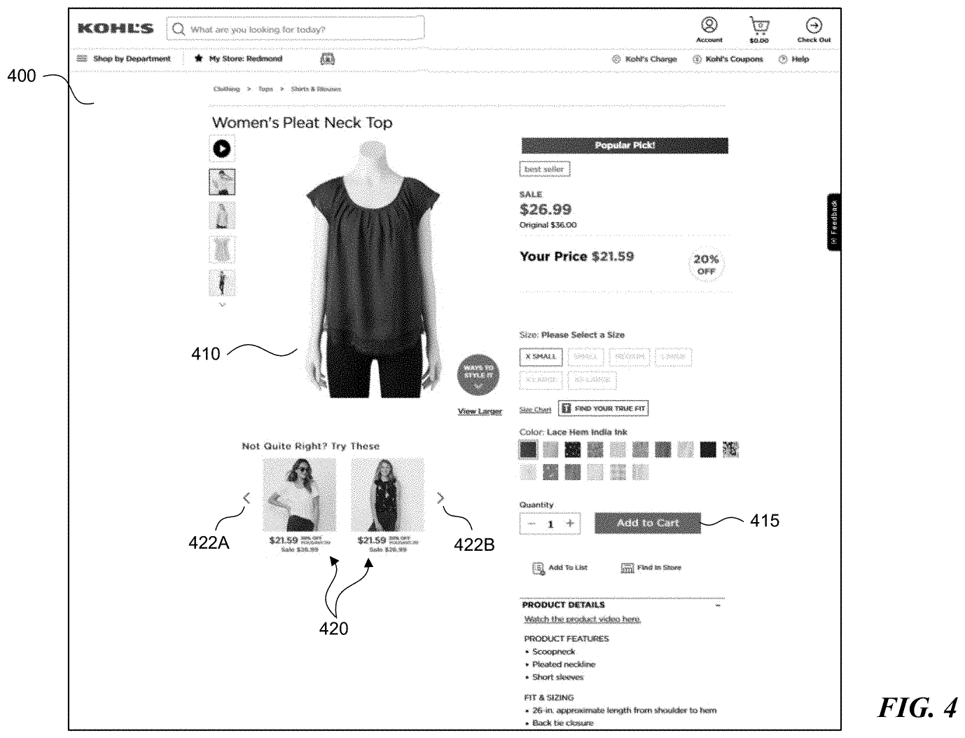

The retailer's website 310 includes web pages that can be accessed and viewed by customers using customer computing devices. FIG. 4 illustrates an example webpage 400 of the retailer's website 310 for a shirt 410 that is sold through the website. The product page 400 can include information about the shirt 410 to assist a customer in deciding whether to purchase the shirt, such as images or videos of the product, a price, color and size options, or materials. The product page 400 can also enable a customer to purchase the product shown on the page, for example by selecting an “Add to Cart” button 415.

The retailer's website 310 selects and displays recommendations to customers visiting the site, for example to help customers find products of interest or to encourage the customers to explore additional products they may otherwise have not found on the site. FIG. 4, for example, shows that the product webpage 400 can display a set of product recommendations 420 in addition to the information about the shirt 410. The product recommendations 420 are products selected by the website 310 applying recommendation algorithms in a recommendation algorithm bundle, as described herein. The product webpage 400 can have a specified number of recommendation slots to be filled by recommendations, such as 15 slots. In the example of FIG. 4, only two recommendations (corresponding to two recommendation slots) are shown, but additional recommendations can be viewed by selecting the backward or forward arrows 422A, 422B.

Some implementations of the retailer's website 310 can execute the recommendation algorithms to select the recommendations to fill the specified number of slots at the time the webpage 400 is loaded for display on a customer's device. Other implementations periodically execute the algorithms, such as once per hour, and store identifiers of the product recommendations selected based on the executed algorithms. The stored product recommendations are then loaded and displayed on the webpage whenever the page is accessed.

Returning to FIG. 3, the recommendation bundle storage 320 stores computer program code for each of multiple recommendation algorithms. Each recommendation algorithm represents a process that can be applied by the retailer's website 310 to information associated with the customer, a product the customer is currently viewing, or contextual information to select a set of recommendations for display via the website 310. Example algorithms in the bundle pool for generating product recommendations include algorithms that select recommended products based on the current product a customer is viewing, such as “people who bought this, also bought this;” product similarity algorithms that determine products with similar type, color, shape, price, or other attributes to the currently viewed product; or product relatedness algorithms that determine, for example, whether two products are typically used together (such as light bulbs for a lamp, or a sleep shirt that matches the sleep pants a customer is viewing). Other example algorithms include those that select recommended products based on global customer preferences rather than the specific product a customer is currently viewing, such as most popular items or trending items, or those that select recommended products that are similar to those the customer previously viewed or purchased. Some of the algorithms in the recommendation bundle storage 320 may be ensemble methods that use two or more types of algorithms to generate a set of recommendations. Furthermore, some of the algorithms may only under some circumstances. For example, some algorithms may be applied only when a customer is logged into an account via the retailer's website 310 (e.g., such that the website is able to access past purchase history, the customer's location, or a preferences profile of the customer), while other algorithms are applicable to any customer whether logged-in or not.

The performance monitoring system 330 measures performance of recommendations presented through the retailer's website 310 and selects recommendation algorithm bundles based on the measured performance. The performance monitoring system 330 can measure performance according to a specified performance metric by, for example, detecting a number of user selections (e.g., clicks) of the recommendations when displayed on a website, a number of times a customer who viewed a recommendation added the corresponding product to an online shopping cart, or a number of times the customer who viewed a recommendation completed a purchase of the corresponding product. Platforms other than a website offering products for sale may measure performance differently, as relevant to the platform. For example, a video streaming platform may measure performance by detecting a number of users who begin to watch a recommended video or a number of users who watch a threshold amount of a recommended video (e.g., at least half, or at least 90% of the video). A platform for generating offers for customers to use in a store (whether physical or online) may measure performance by determining a number of users who access a displayed offer or a number of customers who use the offer to make a purchase.

The performance measured by the performance monitoring system 330 can be converted into “rewards,” quantifying whether or to what degree a set of recommendations achieved a target metric. Using the rewards, the performance monitoring system can also generate a probability distribution representing probabilities that the set of recommendations generated by a given recommendation bundle will achieve a particular reward (e.g., whether the recommendations will result in achievement of a specified performance metric, such as a specified click-through rate). In some implementations, the probability distribution generated by the performance monitoring system 330 is a posterior probability distribution that has shape parameters selected to fit the distribution to observed performance data.

The scale reactor system 340 scales the recommendation bundle performance to improve the recommendations generated by the retailer's website 310. The scale reactor system 340 detects a triggering condition for a scaling cycle and, in response to detecting the trigger condition, scale a probability distribution associated with a performance of recommendation bundles to cause the performance monitoring system 330 to explore the recommendation bundles. The scaling mechanism is described further below.

### Generating Recommendations by a Recommendation System

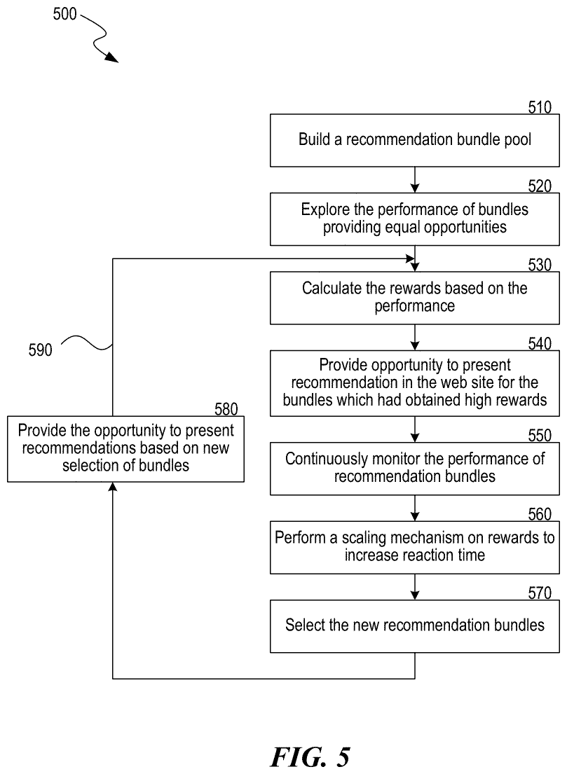

FIG. 5 is a flow diagram showing a process 500 performed by the recommendation system 300 to generate recommendations, according to some implementations. The process shown in FIG. 5 can be performed by one or more processors, such as the CPU 101 of the computer system 100, based on execution of computer program instructions stored in a non-transitory computer readable medium, such as the computer memory 102, the persistent storage device 103, or the computer-readable media drive 104. Other implementations of the process 500 can include additional, fewer, or different steps, and the steps can be performed in different orders. The process 500 can enable the recommendation system 300 to select multiple recommendation algorithms for the retailer's website 310 to apply together in order to populate a desired number of recommendation slots on a webpage. Because each algorithm individually may not generate enough recommendations to fill the desired slots, using multiple algorithms together can enable the retailer's website 310 to generate a sufficient number of recommendations.

As shown in FIG. 5, the recommendation system 300 builds a recommendation bundle pool at block 510. The recommendation bundle pool includes multiple recommendation algorithms, each of which is capable of generating one or more recommendations. For example, in implementations where the recommendation system 300 generates product recommendations for the retailer's website 310, each algorithm in the recommendation bundle pool selects one or more products from a product database associated with the website 310.

At block 520, the recommendation system 300 explores performance of recommendation bundles selected from the recommendation bundle pool. Each recommendation bundle can include multiple recommendation algorithms. During the exploration phase performed at block 520, the recommendation system 300 can explore each recommendation bundle by generating a set of recommendations using the algorithms in the bundle. The set of recommendations can be sorted according to any of a variety of sorting mechanisms and displayed on the retailer's website 310 in the sorted order. The recommendations can instead be displayed in a random order in some implementations.

The recommendation system 300 can give each recommendation bundle approximately equal opportunities in which performance is measured. The recommendation system 300 can use any of a variety of variables to determine whether the bundles are afforded equal opportunities. For example, sets of recommendations generated by each bundle can be displayed for approximately equal amounts of time on the retailer's website 310, to approximately equivalent numbers and/or types of visitors to the website, for an approximately equivalent number of page views, or for an approximately equivalent number of sessions on the website. The recommendation system 300 tracks a display rate of the recommendations associated with each bundle according to the selected variable to ensure that each bundle is afforded approximately equal opportunities. For example, if the recommendation system 300 targets giving each bundle an equivalent number of page views, the recommendation system 300 counts the number of page views for which each bundle's recommendations were displayed. When a new page view is requested, the recommendation system 300 identifies a bundle that has a lower number of page views than other bundles, and uses the identified bundle to generate the recommendations to display on the requested page. Each bundle can be initiated using default settings on approximately equal distributions to help ensure equal opportunities.

As the set of recommendations associated with each bundle are displayed, the recommendation system 300 captures specified metrics indicative of performance of the bundle. Example metrics include click-through rate of the generated recommendations, add-to-cart rate of the recommended products, or purchase rate of the recommended products. By exploring the possible combinations of recommendation bundles in the bundle pool, the recommendation system 300 can measure the ability of multiple algorithms together to generate a set of product recommendations that achieve a performance metric.

At block 530, the recommendation system 300 calculates rewards for each bundle based on the measured performance metrics. The reward calculation can comprise a mathematical function to transform the performance of recommendation bundles to numerical figures. A reward can indicate whether, or to what extent, a bundle achieved a desired performance. For example, the recommendation system 300 can calculate a reward of 1 if the recommendations generated by a bundle achieve a click-through rate that is greater than a specified threshold (e.g., 5%), and a reward of 0 if the recommendations achieve a click-through rate that is less than the specified threshold. Rewards can be binary values or different, non-binary values.

Using the calculated rewards, the recommendation system 300 can select one or more of the recommendations bundles at block 540 to present recommendations through the retailer's website 310. When selecting the bundles, the recommendation system 300 can select at least a first bundle that has a highest probability of success according to a specified performance metric or criteria. For example, the recommendation system 300 can select one or more of the bundles that obtained a highest number of rewards or any bundles that received a number of rewards above a specified threshold. The retailer's website 310 can use the selected bundles to generate recommendations for display to customers.

While the selected recommendation bundles are used to generate recommendations and at block 550, the recommendation system 300 continuously monitors performance of the recommendation bundles. The recommendation system 300 can measure the performance in response to a trigger condition or at predefined intervals. For example, the recommendation system 300 measures click-through rate of the recommendations generated by the bundle in ten-minute increments.

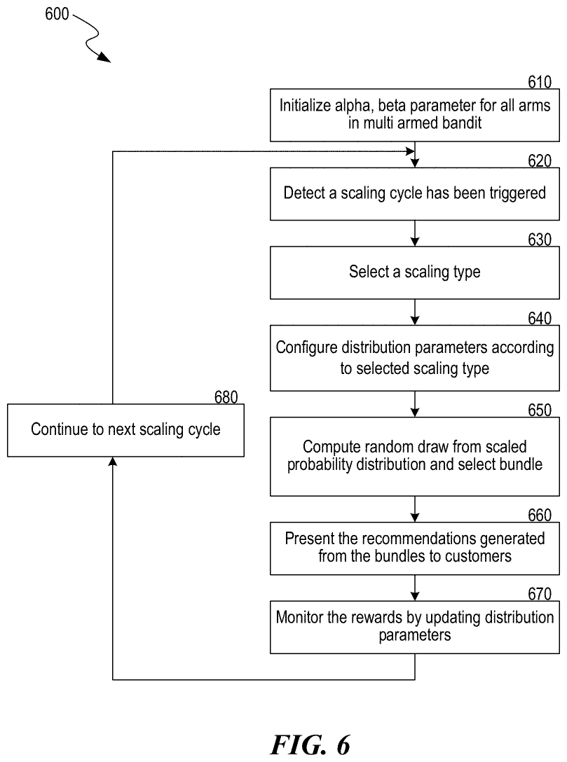

At block 560, the recommendation system 300 performs a scaling mechanism on the rewards to increase recommendation reaction time. The scaling mechanism can be performed periodically or in response to a triggering condition. For each of multiple recommendation bundles, the scaling mechanism can artificially increase a variance in the recommendation system's calculated probability of achieving a particular reward. The higher variance forces the recommendation system 300 to explore other recommendation bundles selected from the bundle pool to determine if the other recommendation bundles achieve better performance than a recommendation bundle the system is exploiting prior to the scaling cycle. The scaling mechanism is described further with respect to FIG. 6.

Based on the scaling mechanism, the recommendation system 300 selects one or more new recommendation bundles at block 570, and provides the new bundles with an opportunity to generate recommendations for display to website visitors at block 580. For example, the recommendation system 300 selects a bundle that has a highest measured performance.

The recommendation system 300 continues to monitor performance of the selected bundles, repeating (590) the scaling mechanism to continuously adapt the recommendation bundles to changing customer preferences.

### Scaling Recommendation Bundle Selections

As described above, the recommendation system 300 exploits one or more recommendation bundles that are selected from the bundle pool based on an exploration of the performance of bundles in the pool. However, the customer preferences and interests that existed at the time the bundle pool was explored may change over time. These changing preferences and interests can cause degradation in the performance of the selected recommendation bundles, and correspondingly there may be different recommendation bundles that will achieve better performance metrics under the new customer environment. To address dynamically changing customer interests, the recommendation system 300 uses a scaling mechanism to evaluate the performance of recommendation bundles and, if relevant, select new recommendation bundles that will better achieve the performance metrics.

A process 600 for scaling selection of recommendation bundles in order to dynamically respond to changing user interests is shown in FIG. 6. The process 600 can be performed by the recommendation system 300. The process shown in FIG. 6 can be performed by one or more processors, such as the CPU 101 of the computer system 100, based on execution of computer program instructions stored in a non-transitory computer readable medium, such as the computer memory 102, the persistent storage device 103, or the computer-readable media drive 104. Other embodiments of the process 600 can include additional, fewer, or different steps, and the steps can be performed in different orders.

As shown in FIG. 6, the recommendation system 300 initializes, at block 610, parameters for each of a plurality of probability distributions. Each probability distribution is indicative of performance of a recommendation bundle selected from the bundle pool. For example, each probability distribution represents probabilities of achieving various rewards when recommendations are generated by the corresponding recommendation bundle. The parameters of the distribution can specify shape and/or width of the distribution, and the recommendation system 300 can initialize the parameters by determining values for the parameters that will cause the probability distribution to match, with less than a threshold error, the observed performance of the recommendations.

At block 620, the recommendation system 300 detects that a scaling cycle has been triggered. In some implementations, the scaling cycle is triggered at a pre-defined frequency. For example, the recommendation system 300 can be configured with a frequency parameter defining how often the recommendation system 300 will perform a scaling process. In other implementations, the scaling cycle is triggered upon detection of a condition in the measured recommendation bundle performances. For example, the scaling cycle is triggered if the recommendation system 300 detects that a difference between mean value of expected performance of two or more explored bundle exceeds a threshold difference, indicating that exploration of non-winning bundles has stopped.

When the scaling process is triggered, the recommendation system 300 selects a scaling type at block 630. The scaling type can correspond to a value or mechanism for scaling one or more parameters of the probability distribution in order to force the recommendation system 300 to explore performance of other recommendation bundles. In some implementations, the recommendation system 300 selects between a bounded scale mechanism and a geometric scale mechanism. The recommendation system 300 may select either the bounded scale or geometric scale mechanism if the system is automatically selecting the scaling value. If instead the recommendation system 300 is applying pre-defined parameters (as specified, for example, by a designer of the recommendation system 300), the recommendation system 300 may select the geometric scaling mechanism to avoid increasing regret.

At block 640, the recommendation system 300 implements the selected scaling mechanism by using the mechanism to configure parameters of probability distributions that each represent the performance of each of a plurality of recommendation bundles. For each type of scaling mechanism, the recommendation system 300 can apply a scaling value to at least one parameter of the probability distribution to scale the parameter. Scaling the parameter can effectively generate a new probability distribution that, for example, has the same mean value as the unscaled distribution but a higher variance.

To implement a bounded scale mechanism, the recommendation system 300 can use a mathematical formula to verify whether numerical parameters of the probability distribution of each recommendation bundle exceed a selected or configurable upper bound. If the upper bound is exceeded, the recommendation system 300 adjusts the numerical parameters of the posterior distribution corresponding to each recommendation bundle to fall below the upper bound. The recommendation system 300 can adjust the parameters by subtracting a specified value from each parameter or multiplying the parameters by a scaling factor that will reduce the value of the parameters. The scaling of the distribution's parameters results in a higher variance of the distribution and a lower confidence in the distribution's mean. This increased variance, in turn, causes the recommendation system 300 to explore performance of different recommendation bundles selected from the recommendation bundle pool.

In some implementations, the recommendation system 300 automatically selects the upper bound for the bounded scale mechanism using iteratively conducted offline tests to select a value that ensures a desired percentage of exploration. Furthermore, several upper bound values can be used in the online setting and exploration and consequently the rewards can be observed. The value of the upper bound can be selected based on the observed rewards. For example, the recommendation system 300 can select the value that achieves the highest overall reward, or a value that achieves a reward that is greater than a specified threshold. Other implementations of the recommendation system 300 determine the upper bound parameters automatically based on feedback from user behavior to ensure exploration of other recommendation bundles.

If the recommendation system 300 instead selects a geometric scaling mechanism at block 630, the recommendation system 300 implements the mechanism at block 640 by using a scaling constant value to scale numerical parameters of the probability distribution corresponding to each recommendation bundle. The scaling constant value can be a configurable parameter of the recommendation system 300. The scaling constant value can be selected based on offline evaluation to achieve a specified percentage of exploration, or based on online evaluation to increase rewards. When the parameters of the probability distribution are scaled using the scaling constant value, the recommendation system 300 increases variance of the probability distributions and therefore increases exploration of other recommendation bundles.

As an example, the scaling constant value is a common ratio parameter for a geometric sequence that scales down the parameters of the probability distribution based on a geometric sequence. In some implementations, the scaling constant value is applied at each scaling cycle by multiplying the parameter at the previous cycle by the scaling constant value to generate a new parameter for the probability distribution. In other implementations, the parameter is reset at each scaling cycle or a subset of the scaling cycles before being multiplied by the scaling constant value.

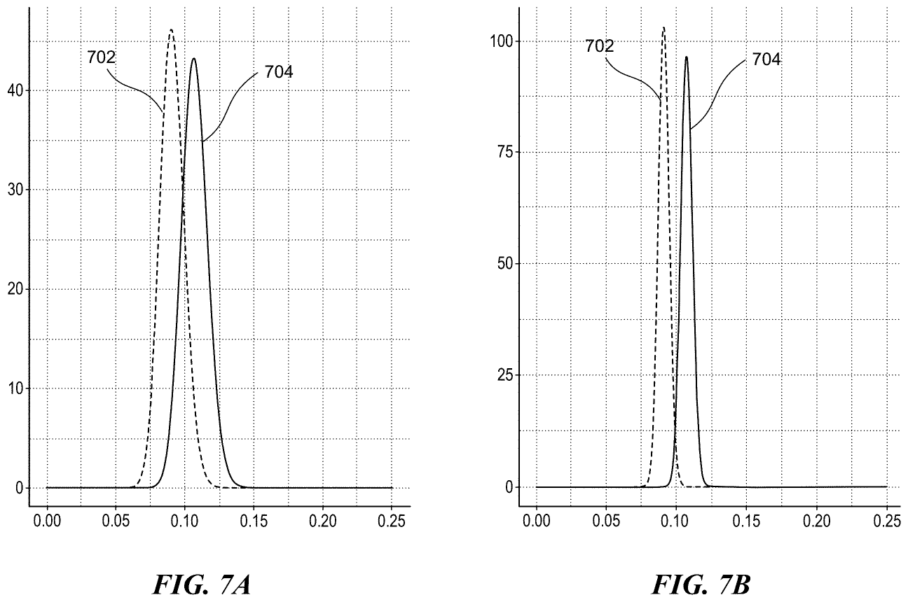

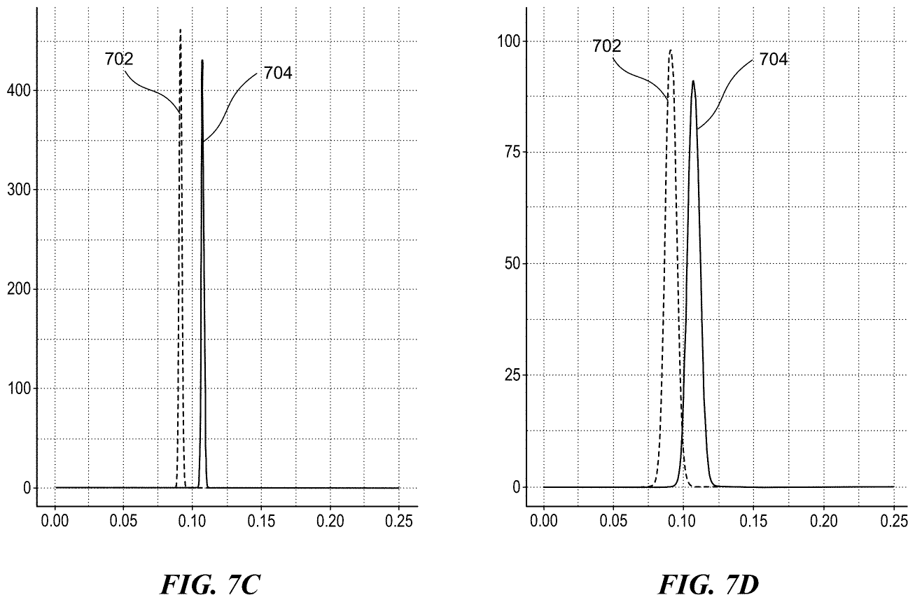

Example scaling of probability distributions is shown in FIGS. 7A-7D. Two distributions 702, 704 are shown in FIG. 7A, where each distribution shows the probability of achieving a reward when performance of a given recommendation bundle is evaluated. In the example of FIG. 7A, the probability distribution 704 has a higher mean value than the probability distribution 702. As the recommendation system 300 generates recommendations and measures resulting performance of the two recommendation bundles, the probability distributions 702, 704 narrow because the recommendation system 300 has collected more data about the bundles' respective performance. FIG. 7B illustrates the distributions 702, 704 after a period of exploiting the corresponding recommendation bundles, and FIG. 7C illustrates the distributions 702, 704 after still further exploitation.

Under the conditions shown in FIG. 7C, the recommendation system 300 may only (or nearly always) select the recommendation bundle corresponding to distribution 704, causing the retailer's website 310 to only (or nearly only) display recommendations generated by the recommendation bundle corresponding to distribution 704. If customer preferences or interests later change, for example such that the recommendation bundle corresponding to distribution 702 would achieve better performance than the bundle corresponding to distribution 704, the recommendation system 300 may not capture the change unless the performance of the recommendation bundle corresponding to distribution 702 is explored. To force further exploration, the recommendation system 300 scales the parameters of the probability distributions as described above. FIG. 7D, for example, illustrates the probability distributions 702, 704 have been scaled by the scaling constant value, increasing the variance of the probability distributions. Under the conditions shown in FIG. 7D, the recommendation system 300 will explore performance of both recommendation bundles. Although FIGS. 7A-7D show two probability distributions for comparison, the recommendation system 300 can perform a similar process to scale any number of probability distributions each corresponding to a different recommendation bundle selected from the bundle pool.

Returning to FIG. 6, the recommendation system 300 at block 650 computes a random draw from the probability distributions as scaled, observes which distributions yield a higher value (for example, using Thompson sampling), and selects one or more recommendation bundles that yield higher values.

At block 660, the recommendation system 300 generates a set of recommendations using the selected recommendation bundle and provides the recommendations to one or more customers. For example, the recommendations are displayed on a webpage of the retailer's website 310, as shown in FIG. 4. The recommendation system monitors performance and corresponding rewards of the presented recommendations at step 670, updating the probability distribution parameters as the performance data is collected.

At block 680, the recommendation system 300 continues generating recommendations and monitoring performance until a next scaling cycle has been triggered.

Additional Considerations

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number can also include the plural or singular number respectively. The word “or,” in reference to a list of two or more items, covers all of the following interpretations of the word: any of the items in the list, all of the items in the list, or any combination of the items in the list.

The above detailed description of implementations of the system is not intended to be exhaustive or to limit the system to the precise form disclosed above. While specific implementations of, and examples for, the system are described above for illustrative purposes, various equivalent modifications are possible within the scope of the system, as those skilled in the relevant art will recognize. For example, some network elements are described herein as performing certain functions. Those functions could be performed by other elements in the same or differing networks, which could reduce the number of network elements. Alternatively, or additionally, network elements performing those functions could be replaced by two or more elements to perform portions of those functions. In addition, while processes, message/data flows, or blocks are presented in a given order, alternative implementations can perform routines having blocks, or employ systems having blocks, in a different order, and some processes or blocks can be deleted, moved, added, subdivided, combined, and/or modified to provide alternative or subcombinations. Each of these processes, message/data flows, or blocks can be implemented in a variety of different ways. Also, while processes or blocks are at times shown as being performed in series, these processes or blocks can instead be performed in parallel, or can be performed at different times. Further, any specific numbers noted herein are only examples: alternative implementations can employ differing values or ranges.

The teachings of the methods and system provided herein can be applied to other systems, not necessarily the system described above. The elements, blocks and acts of the various implementations described above can be combined to provide further implementations.

Any patents and applications and other references noted above, including any that can be listed in accompanying filing papers, are incorporated herein by reference. Aspects of the technology can be modified, if necessary, to employ the systems, functions, and concepts of the various references described above to provide yet further implementations of the technology.

These and other changes can be made to the invention in light of the above Detailed Description. While the above description describes certain implementations of the technology, and describes the best mode contemplated, no matter how detailed the above appears in text, the invention can be practiced in many ways. Details of the system can vary considerably in its implementation details, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the invention to the specific implementations disclosed in the specification, unless the above Detailed Description section explicitly defines such terms. Accordingly, the actual scope of the invention encompasses not only the disclosed implementations, but also all equivalent ways of practicing or implementing the invention under the claims.

While certain aspects of the technology are presented below in certain claim forms, the inventors contemplate the various aspects of the technology in any number of claim forms. For example, while only one aspect of the invention is recited as implemented in a computer-readable medium, other aspects can likewise be implemented in a computer-readable medium. Accordingly, the inventors reserve the right to add additional claims after filing the application to pursue such additional claim forms for other aspects of the technology.

We claim:

1. A method comprising:
accessing by a computer system, a recommendation bundle pool including multiple recommendation algorithms each capable of generating one or more recommendations;
selecting, by the computer system, a first recommendation bundle from the recommendation bundle pool, the first recommendation bundle including two or more recommendation algorithms;
generating, by the computer system, recommendations to provide to visitors to a website using the recommendation algorithms of the first recommendation bundle;
detecting, by the computer system, a triggering condition for a scaling cycle;
responsive to detecting the triggering condition, applying, by the computer system, a scaling mechanism to increase an exploration of additional recommendation bundles selected from the recommendation bundle pool;
selecting, by the computer system, a second recommendation bundle from the recommendation bundle pool based on the exploration of the additional recommendation bundles; and
generating multiple recommendations to provide to the visitors to the website using the recommendation algorithms in the second recommendation bundle.

2. The method of claim 1 wherein selecting the first recommendation bundle comprises:
generating a set of recommendations by each of a plurality of recommendation bundles selected from the recommendation bundle pool;
measuring performance of the set of recommendations generated by each of the plurality of recommendation bundles; and
selecting the first recommendation bundle based on the measured performances.

3. The method of claim 2 wherein selecting the first recommendation bundle based on the measured performances comprises selecting a recommendation bundle of the plurality of recommendation bundles that has a highest probability of achieving specified performance criteria.

4. The method of claim 2 wherein measuring the performance of the sets of recommendations comprises using each of the plurality of recommendation bundles to generate sets of recommendations for approximately equivalent numbers of website page loads.

5. The method of claim 2 wherein measuring the performance of the sets of recommendations comprises measuring at least one of a click-through rate, an add-to-cart rate, or a purchase rate associated with at least one of the recommendations in each set.

6. The method of claim 1 wherein applying the scaling mechanism comprises:
measuring performance of the recommendations generated using the first recommendation bundle;
initializing, by the computer system, a parameter of a first probability distribution to the measured performed of the recommendations generated using the first recommendation bundle; and
responsive to detecting the triggering condition, applying a scaling value to the parameter of the first probability distribution to generate a second probability distribution.

7. The method of claim 6 wherein applying the scaling value comprises:
detecting a value of the parameter of the first probability distribution exceeds a configured upper bound; and
applying the scaling value to reduce the value of the parameter below the configured upper bound.

8. The method of claim 6 wherein applying the scaling value comprises:
scaling the parameter by a common ratio defined for a geometric sequence.

9. The method of claim 1 wherein the triggering condition is a frequency parameter defining a frequency at which the computer system performs the scaling mechanism.

10. The method of claim 1 wherein the triggering condition is a detection, by the computer system, that a difference between a mean value of expected performance of two or more bundles exceeds a threshold difference.

11. The method of claim 1 wherein generating the recommendations using the recommendation algorithms in the first recommendation bundle comprises:
receiving a request to load a webpage of the website; and
applying the recommendation algorithms in the first recommendation bundle to information associated with the webpage, wherein the recommendation algorithms in the first recommendation bundle, when applied to the information associated with the webpage, output the generated recommendations.

12. The method of claim 11 wherein the computer system uses the recommendation algorithms in the first recommendation bundle to generate a plurality of recommendations to fill a specified quantity of recommendation slots on the webpage.

13. A method comprising:
generating, by a recommendation system, a first set of recommendations using a first recommendation bundle, the first recommendation bundle including two or more recommendation algorithms selected from a recommendation bundle pool based on measured performance of the first recommendation bundle to achieve a metric associated with the first set of recommendations;
sending, by the recommendation system, the first set of recommendations for display to visitors to a website;
responsive to detecting a triggering condition for a scaling cycle, applying, by the recommendation system, a scaling mechanism to the measured performance of the first recommendation bundle based on the first set of recommendations displayed to the visitors to the website and to measured performance of one or more additional recommendation bundles;
selecting, by the recommendation system, a second recommendation bundle based on the scaling mechanism, the second recommendation bundle including two or more recommendation algorithms selected from the recommendation bundle pool based on the measured performance of the second recommendation bundle;
generating, by the recommendation system, a second set of recommendations using the second recommendation bundle; and
sending, by the recommendation system, the second set of recommendations for display to the visitors to the website.

14. The method of claim 13 wherein applying the scaling mechanism to the measured performance of the first recommendation bundle comprises:
initializing, by the recommendation system, a parameter of a first probability distribution to the measured performed of the first recommendation bundle; and
responsive to detecting the triggering condition, applying a scaling value to the parameter of the first probability distribution to generate a second probability distribution.

15. The method of claim 14 wherein applying the scaling value comprises:
detecting a value of the parameter of the first probability distribution exceeds a configured upper bound; and
applying the scaling value to reduce the value of the parameter below the configured upper bound.

16. The method of claim 14 wherein applying the scaling value comprises:
scaling the parameter by a common ratio defined for a geometric sequence.

17. The method of claim 13 wherein the triggering condition is a frequency parameter defining how frequently the recommendation system performs the scaling mechanism.

18. The method of claim 13 wherein the triggering condition is a detection, by the recommendation system, that a difference between a mean value of expected performance of two or more bundles exceeds a threshold difference.

19. The method of claim 13 wherein generating the recommendations using the recommendation algorithms in the first recommendation bundle comprises:
receiving a request to load a webpage of the website; and
applying the recommendation algorithms in the first recommendation bundle to information associated with the webpage, wherein the recommendation algorithms in the first recommendation bundle when applied to the information associated with the webpage output the generated recommendations.

20. A recommendation system comprising:
a processor; and
a non-transitory computer readable storage medium storing executable computer program instructions, the computer program instructions when executed by the processor causing the processor to:
generate a first set of recommendations using a first recommendation bundle, the first recommendation bundle including two or more recommendation algorithms selected from a recommendation bundle pool based on measured performance of the first recommendation bundle to achieve a metric associated with the first set of recommendations;
display the first set of recommendations to visitors to a website;
responsive to detecting a triggering condition for a scaling cycle, apply a scaling mechanism to the measured performance of the first recommendation bundle and measured performance of one or more additional recommendation bundles;
select a second recommendation bundle based on the scaling mechanism, the second recommendation bundle including two or more recommendation algorithms selected from the recommendation bundle pool based on the measured performance of the second recommendation bundle;
generate a second set of recommendations using the second recommendation bundle; and
display the second set of recommendations to the visitors to the website.
